(19) United States
(12) Patent Application Publication
(10) Pub. No.: US 2005/0249591 A1
(43) Pub. Date: Nov. 10, 2005

(54) Rotary ram-out vacuum pump

(76) Inventor: Essam T. Awdalla, Raleigh, NC (US)

Correspondence Address: Essam T. AWDALLA;RRC-SGTE Technologies, LLC, Suite 321, 510 Glenwood Avenue, Raleigh, NC, 27603, US

(21) Appl. No.: 11/181,078

(22) Filed: Jul. 14, 2005

Related U.S. Application Data
(63) Continuation-in-part of application No. 11/093,138, filed on Mar. 29, 2005.
Application No. 11/093,138 is a continuation-in-part of application No. 10/669,514, filed on Sep. 23, 2003, now Pat. No. 6,877,951.
Application No. 11/093,138 is a continuation-in-part of application No. 11/070,914, filed on Mar. 3, 2005.

(51) Int. Cl. F03C 2/00

(52) U.S. Cl. 415/199.2

(57) ABSTRACT

A rotary ram-out vacuum pump, used for decreasing the pressure of a gas within a space ahead of the vacuum pump, comprising: a stationary casing having at least one inlet passage communicating with the space ahead of the vacuum pump, and at least one exit passage freely communicating with surrounding atmospheric air; a drive shaft supported for rotation inside the casing; and a rotor assembly housed inside the casing and including a plurality of sweeping channels. In operation, gas is rammed out, through the sweeping channels of the vacuum pump, from the space ahead of the vacuum pump to surrounding atmospheric air, and thus decreasing the density and pressure of the gas in the space ahead of the vacuum pump.

### CROSS-REFERENCE TO RELATED APPLICATION(S)

This non-provisional utility patent application claims the benefit of two prior filed co-pending non-provisional applications; the present application is a continuation-in-part of U.S. patent application Ser. No. 11/093,138 filed on Mar. 29, 2005, which is a continuation in part of U.S. patent application Ser. No. 10/669,514, filed Sep. 23, 2003, and U.S. patent application Ser. No. 11/070914, filed Mar. 3, 2005, which are incorporated herein by reference in their entirety.

### FIELD OF THE INVENTION

The present invention relates to a vacuum pump and, more particularly, to a rotary ram-out vacuum pump used for decreasing the density and pressure level of a gas in a space ahead of the vacuum pump.

### BACKGROUND OF THE INVENTION

Rotary vacuum pumps are well known devices, used in several fields either to reduce the density and pressure of gas or air in a container, or to decrease the density and pressure of gas or air at their inlet passages. Two main types of rotary vacuum pumps are currently in use, rotary oil-seal pumps, and dynamic vacuum pumps. The main components of a conventional rotary oil-seal pump are a casing; and a rotating element mounted within the casing, with contact sealing means usually provided between the opposing surfaces of the casing and the rotating element, which limits their maximum allowable operating rotational speeds, and hence their maximum provided mass flow rates, due to the developed friction between the rubbing parts within them. Although conventional types of dynamic vacuum pumps have no rubbing parts within them, and thus they can handle relatively higher mass flow rates, yet they must operate within a relatively narrow range of high rotational speeds to provide appreciable degrees of pressure drop ahead of the vacuum pump.

Thus, there is a need for a rotary vacuum pump, having no rubbing parts within it, which can operate within a wide range of operating rotational speeds, to provide variable degrees of pressure drop in the space ahead of the pump.

Prior art made of record includes the inventor's earlier U.S. Pat. No. 6,877,951, and U.S. patent application Ser. Nos. 11/070,914 and 11/093,138, which provide several Rotary ram-in Compressors, wherein working gases are rammed through feeding channels moving at high speed, followed by positive displacement of the rammed-in gases to a receiver wherein pressurized gases collect. Then, the pressurized gases are either actively swept from the receiver by a successive rotary ram-in compressor or a successive rotary ram compressor, or collected within a container communicating with the receiver through a conduit. However, none of these teaches the rotary ram-out concept, or its use to sweep gases from a space ahead of a vacuum pump, and thus providing a negative pressure gradient between two points across a stream of gases.

Prior art made of record, which is not relied upon, includes U.S. Pat. No. 4,227,868 by Nishikawa et al., U.S. Pat. No. 4,278,399 by Erickson, U.S. Pat. No. 4,358,244 by Nishikawa et al., U.S. Pat. No. 6,739,835 by Kim, Japan Pat. No. JP354013002A, Japan Pat. No. JP35508794A, and German Pat. No. DE3243169A1. Each of them showing a compressor impeller having a first disk and a second disk and a plurality of vanes arranged there-between.

### SUMMARY OF THE INVENTION

The present invention provides a rotary vacuum pump having no rubbing parts within, which allows its use in the applications wherein relatively high mass flow rates are needed, and which can operate within a wide range of operating rotational speeds, to provide variable degrees of pressure drop in the space ahead of the vacuum pump.

Accordingly, the present invention provides a rotary ram-out vacuum pump, used for decreasing the pressure of a gas in a space ahead of the vacuum pump. The rotary ram-out vacuum pump has a plurality of sweeping channels, moving at high speed, through which the gas to be vacuumed is rammed, followed by positive displacement of the rammed out gas to surrounding atmospheric air.

In a preferred embodiment, the rotary ram-out vacuum pump is used for decreasing the pressure of a gas within a container, and comprises: a stationary casing having at least one inlet passage communicating with the said container, and at least one exit passage freely communicating with surrounding atmospheric air; a drive shaft supported for rotation in a given direction inside the casing by an arrangement of bearings, and extending to a drive receiving end located outside the casing; and a rotor assembly housed inside the casing and including a first disk secured for rotation with the drive shaft and lying in a first plane transverse to the rotational axis of the drive shaft; a second disk lying in a second plane transverse to the rotational axis of the drive shaft, with the inner surfaces of the two disks defining an annular space in-between; and a plurality of vanes arranged circumferentially within said annular space, each vane attached to both disks defining the annular space, each vane has a leading edge, a trailing edge, a concave surface and a convex surface, with the average angles of inclination of the successive portions of the vane with respect to a plane comprising the midpoint of the vane and perpendicular to a radial plane including the rotational axis of the rotor and the midpoint of the vane decreases preferably gradually from its leading edge towards its trailing edge, within a range from about +18 to about−18 degrees, the opposing parts of the surfaces of each two adjacent vanes along with the opposing parts of the two disks' surfaces confined between the opposing parts of the surfaces of each two adjacent vanes defining a sweeping channel between them, each sweeping channel has an inlet communicating with the vacuum pump's inlet passage(s) and an outlet communicating with the vacuum pump's exit passage(s).

In operation, gas is rammed out of the container, through the sweeping channels of the vacuum pump, which displace it in a generally radially inward direction (when a radial in-flowing rotary ram-out vacuum pump is used), or in a generally radially outward direction (when a radial out-flowing rotary ram-out vacuum pump is used), to the vacuum pump's exit passage(s), which is freely communicating with surrounding atmospheric air, and thus, decreasing the density and pressure of the gas within the container.

In another preferred embodiment, the rotary ram-out vacuum pump is used for decreasing the pressure of a gas in a space ahead of the vacuum pump, and comprises: a stationary casing having at least one inlet passage communicating with the said space ahead of the pump, and at least one exit passage freely communicating with surrounding atmospheric air; a drive shaft supported for rotation in a given direction inside the casing by an arrangement of bearings, and extending to a drive receiving end located outside the casing; and a rotor assembly housed inside the casing and including a first disk secured for rotation with the drive shaft and lying in a first plane transverse to the rotational axis of the drive shaft; a second disk lying in a second plane transverse to the rotational axis of the drive shaft, with the inner surfaces of the two disks defining an annular space in-between; and a plurality of vanes arranged circumferentially within said annular space, each vane attached to both disks defining the annular space, each vane has a leading edge, a trailing edge, a concave surface and a convex surface, with the average angles of inclination of the successive portions of the vane with respect to a plane comprising the midpoint of the vane and perpendicular to a radial plane including the rotational axis of the rotor and the midpoint of the vane decreases preferably gradually from its leading edge towards its trailing edge, within a range from about +18 to about−18 degrees, the opposing parts of the surfaces of each two adjacent vanes along with the opposing parts of the two disks' surfaces confined between the opposing parts of the surfaces of each two adjacent vanes defining a sweeping channel between them, each sweeping channel has an inlet and an outlet, with the inlets of the sweeping channels communicating with the vacuum pump's inlet passage(s) and with the outlets of the sweeping channels communicating with the vacuum pump's exit passage(s).

In operation, gas is rammed out of the space ahead of the vacuum pump, through the sweeping channels of the vacuum pump, which displace it in a generally radially inward direction (when a radial in-flowing rotary ram-out vacuum pump is used), or in a generally radially outward direction (when a radial out-flowing rotary ram-out vacuum pump is used), to the vacuum pump's exit passage(s), which is freely communicating with surrounding atmospheric air, and thus, decreasing the density and pressure of gas within the space ahead of the vacuum pump.

In a preferred embodiment of the rotary ram-out vacuum pump of the present invention, each two opposing surfaces, of those defining each of the sweeping channels between them, are parallel to one another, with the cross-sectional area of the inlet of each of the channels being equal to the cross sectional area of its outlet.

In another preferred embodiment, in order to increase the level of pressure drop provided by the rotary ram-out vacuum pump of the present invention, each of the sweeping channels is slightly converging from its inlet towards its outlet. The convergence of the sweeping channel is provided by designing the boundaries confining the channel between them so that the axial width of the channel and/or the width between the opposing parts of the surfaces of the two adjacent vanes confining the channel between them decrease preferably gradually from the inlet of the channel towards its outlet, and hence, the cross-sectional area of the channel decreases preferably gradually from its inlet towards its outlet.

The gradual decrease in the axial width of the sweeping channel is provided by designing the part(s) of the surface(s) of one (or both) of the disks related to the channel and confined between the opposing parts of the surfaces of the two adjacent vanes so that it is sloping preferably gradually from the inlet of the channel towards its outlet. The gradual decrease in the width between the opposing parts of the surfaces of the two adjacent vanes is provided by designing the vanes with suitable angles of inclination at their different parts, according to the desired rate of convergence of the channel.

### BREIF DESCRIPTION OF THE DRAWINGS

The description of the objects, features and advantages of the present invention, will be more fully appreciated by reference to the following detailed description of the exemplary embodiments in accordance with the accompanying drawings, wherein:

FIG. 1 is a sectional view in a schematic representation of an exemplary embodiment of a rotary ram-out vacuum pump, used for decreasing the pressure of a gas within a container, in accordance with the present invention.

FIG. 2 is a cross sectional view, taken at the plane of line 2-2 in FIG. 1.

FIG. 3 is a sectional view in a schematic representation of another exemplary embodiment of a rotary ram-out vacuum pump, used for decreasing the pressure of a gas in a space ahead of the vacuum pump, in accordance with the present invention.

FIG. 4 is a cross sectional view, taken at the plane of line 4-4 in FIG. 3.

FIG. 5 is a sectional view in a schematic representation of another exemplary embodiment of a rotary ram-out vacuum pump, used for decreasing the pressure of a gas in a space ahead of the vacuum pump, in accordance with the present invention.

FIGS. 6-11 are schematic representations of the alternatives in which the sweeping channels confined between the opposing parts of the surfaces of the adjacent vanes of a rotary ram-out vacuum pump in accordance with the present invention, may be designed.

### DETAILED DESCRIPTION OF THE PREFERRED EMBODIMENTS

Prior filed U.S. patent applications Ser. Nos. 10/669,514, 11/070,914 and 11/093,138 provide rotary ram-in compressors having a plurality of vanes attached to discs, with the opposing parts of each two adjacent vanes defining a feeding channel in-between. In operation, working gases are rammed through the feeding channels, followed by positive displacement of the rammed-in gases to a receiver wherein pressurized gases collect. The pressurized gases are actively swept from the receiver by either a successive rotary ram-in compressor or a successive rotary ram compressor (disclosed in the inventor's earlier International Patent Application Serial Number: PCT/US00/17044, entitled “Rotary ram fluid pressurizing machine”), which enables providing a flowing stream of pressurized gases, and thus making them convenient for use in gas turbine engines, and the like. Or, the pressurized gases collect within a container, and thus, increasing the density and pressure level of the gas within the container.

The present application clearly defines a rotary ram-out vacuum pump, with which gases are swept from a space ahead of the vacuum pump, and thus providing a negative pressure gradient between two points across a stream of gases.

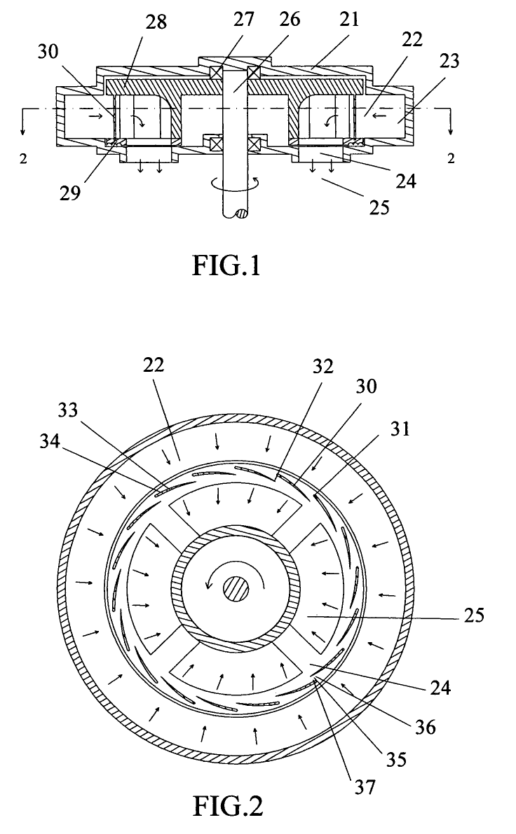

FIG. 1 is a sectional view in a schematic representation of an exemplary embodiment of a rotary ram-out vacuum pump, used for decreasing the pressure of a gas, or air, within a container, in accordance with the present invention.

The main components of the rotary ram-out vacuum pump in this embodiment are a stationary casing (21) having an inlet passage (22) communicating with a container (23) from which gas is vacuumed, and an exit passage (24) freely communicating with surrounding atmospheric air (25); a drive shaft (26) supported for rotation in a given direction inside the casing by an arrangement of bearings (27), and extending to a drive receiving end located outside the casing; and a rotor assembly housed inside the casing and secured for rotation with the drive shaft (26). The rotor assembly includes a first disk (28) secured for rotation with the drive shaft and lying in a first plane transverse to the rotational axis of the drive shaft; a second disk (29) lying in a second plane transverse to the rotational axis of the drive shaft, with the inner surfaces of the two disks defining an annular space in-between; and plurality of vanes (30) arranged circumferentially within said annular space, each vane attached to both disks defining the annular space. As shown in FIG. 2 which is a cross sectional view, taken at the plane of line 2-2 in FIG. 1, each vane (30) has a leading edge (31), a trailing edge (32), a concave surface (33) and a convex surface (34), with the average angles of inclination of the successive portions of the vane with respect to a plane comprising the midpoint of the vane and perpendicular to a radial plane including the rotational axis of the rotor and the midpoint of the vane decreases preferably gradually from its leading edge towards its trailing edge, within a range from about +2 to about−18 degrees, the opposing parts of the surfaces of each two adjacent vanes along with the opposing parts of the two disks' surfaces confined between the opposing parts of the surfaces of each two adjacent vanes defining a sweeping channel (35) between them, each sweeping channel (35) having an inlet (36) communicating with the inlet passage of the vacuum pump (22), and an outlet (37) communicating with the exit passage (24) of the vacuum pump, which is freely communicating with surrounding atmospheric air (25).

In operation, the gas within the container (23) is rammed out through the sweeping channels (35) of the rotary ram-out vacuum pump, followed by displacement of the rammed out gas in a generally radially inward direction by the concave surfaces (33) of the vanes (30), to surrounding atmospheric air (25). Thus, the rotary ram-out vacuum pump in this embodiment provides active sweeping of the gas from the container (23), and hence, decreasing the density and pressure of the gas within the container.

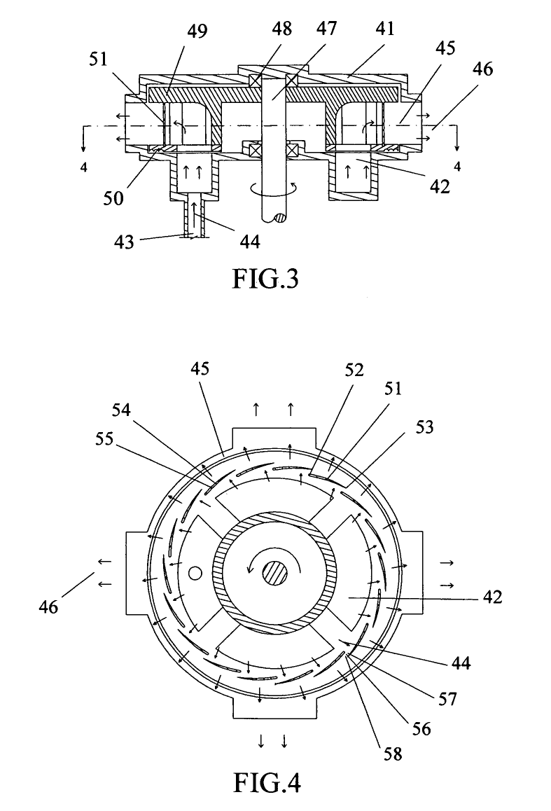

FIG. 3 is a sectional view in a schematic representation of another exemplary embodiment of a rotary ram-out vacuum pump, used for decreasing the pressure of a gas, or air, in a space ahead of the vacuum pump, in accordance with the present invention.

The main components of the rotary ram-out vacuum pump in this embodiment are a stationary casing (41) having an inlet passage (42) communicating with the space ahead of the vacuum pump (43), from which the gas (44) is vacuumed, and an exit passage (45) freely communicating with surrounding atmospheric air (46); a drive shaft (47) supported for rotation in a given direction inside the casing by an arrangement of bearings (48), and extending to a drive receiving end located outside the casing; and a rotor assembly housed inside the casing and secured for rotation with the drive shaft (47). The rotor assembly includes a first disk (49) secured for rotation with the drive shaft and lying in a first plane transverse to the rotational axis of the drive shaft; a second disk (50) lying in a second plane transverse to the rotational axis of the drive shaft, with the inner surfaces of the two disks defining an annular space in-between; and plurality of vanes (51) arranged circumferentially within said annular space, each vane attached to both disks defining the annular space. As shown in FIG. 4 which is a cross sectional view, taken at the plane of line 4-4 in FIG. 3, each vane (51) has a leading edge (52), a trailing edge (53), a concave surface (54) and a convex surface (55), with the average angles of inclination of the successive portions of the vane with respect to a plane comprising the midpoint of the vane and perpendicular to a radial plane including the rotational axis of the rotor and the midpoint of the vane decreases preferably gradually from its leading edge towards its trailing edge, within a range from about +18 to about−2 degrees, the opposing parts of the surfaces of each two adjacent vanes along with the opposing parts of the two disks' surfaces confined between the opposing parts of the surfaces of each two adjacent vanes defining a sweeping channel (56) between them, each sweeping channel (56) having an inlet (57) communicating with the inlet passage of the vacuum pump (42), and an outlet (58) communicating with the exit passage (45) of the vacuum pump, which is freely communicating with surrounding atmospheric air (46).

In operation, the gas within the space ahead of the vacuum pump (44) is rammed out through the sweeping channels (56) of the rotary ram-out vacuum pump, followed by displacement of the rammed out gas in a generally radially outward direction by the convex surfaces (55) of the vanes (51), to surrounding atmospheric air. Thus, the rotary ram-out vacuum pump in this embodiment provides active sweeping of the gas from the space ahead of the vacuum pump (43), and hence, decreasing the density and pressure of the gas within that space.

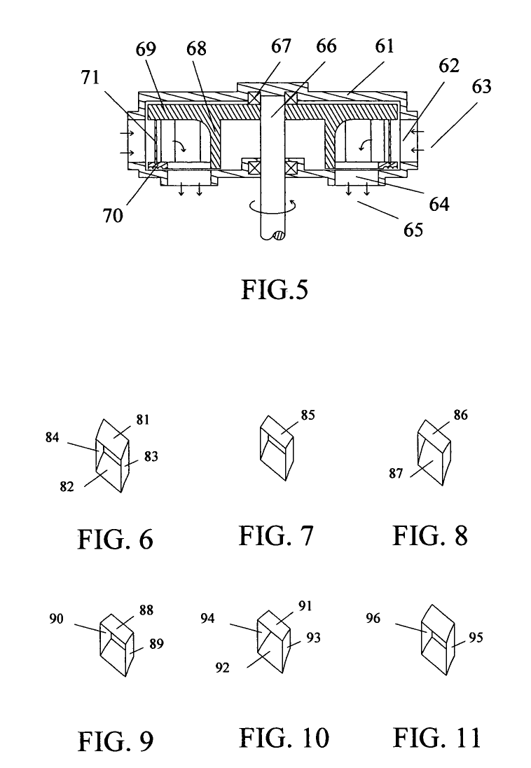

FIG. 5 is a sectional view in a schematic representation of another exemplary embodiment of a rotary ram-out vacuum pump, used for decreasing the pressure of a gas in a space ahead of the vacuum pump, in accordance with the present invention.

The main components of the rotary ram-out vacuum pump in this embodiment are a stationary casing (61) having an inlet passage (62) communicating with the space ahead of the vacuum pump (63), and an exit passage (64) freely communicating with surrounding atmospheric air (65); a drive shaft (66) supported for rotation in a given direction inside the casing by an arrangement of bearings (67), and extending to a drive receiving end located outside the casing; and a rotor assembly (68) housed inside the casing and secured for rotation with the drive shaft (66). The rotor assembly includes a first disk (69) secured for rotation with the drive shaft and lying in a first plane transverse to the rotational axis of the drive shaft; a second disk (70) lying in a second plane transverse to the rotational axis of the drive shaft, with the inner surfaces of the two disks defining an annular space in-between; and plurality of vanes (71) arranged circumferentially within said annular space, with the design and operating principals of the rotor assembly (68) in this embodiment being similar to that of the rotary ram-out vacuum pump of the embodiment of FIGS. 1, 2.

In operation, the gas within the space ahead of the vacuum pump (63) is rammed out through the sweeping channels of the rotary ram-out vacuum pump, followed by displacement of the rammed out gas in a generally radially inward direction by the concave surfaces of the vanes (71), to surrounding atmospheric air (65). Thus, the rotary ram-out vacuum pump in this embodiment provides active sweeping of the gas from the space ahead of the vacuum pump (63).

FIGS. 6-11 are schematic representations of the alternatives in which the sweeping channels confined between the opposing parts of the surfaces of the adjacent vanes of a rotary ram-out vacuum pump in accordance with the present invention, may be designed.

As discussed herein before, the boundaries of each of the sweeping channels are formed of the opposing parts of the surfaces of the two adjacent vanes confining the channel between them (right front and left rear surfaces of the drawings), and of the opposing parts of the disks' surfaces related to the channel and confined between the opposing parts of the surfaces of the two adjacent vanes.

In FIG. 6 each two opposing surfaces (81, 82 & 83, 84), of those defining the sweeping channel between them, are parallel to one another, with the cross-sectional area of the inlet of the channel being equal to the cross sectional area of its outlet.

In FIG. 7 the sweeping channel is slightly converging from its inlet towards its outlet. The convergence of the sweeping channel is provided by designing the boundaries confining the channel between them so that the axial width of the channel decreases gradually from the inlet of the channel towards its outlet, with the gradual decrease in the axial width of the channel provided by designing one (85) of the opposing parts of the disks' surfaces related to the channel and confined between the opposing parts of the surfaces of the two adjacent vanes so that it is gradually sloping from the inlet of the channel towards its outlet.

In FIG. 8 the sweeping channel is slightly converging from its inlet towards its outlet. The convergence of the sweeping channel is provided by designing the boundaries confining the channel between them so that the axial width of the channel decreases gradually from the inlet of the channel towards its outlet, with the gradual decrease in the axial width of the channel provided by designing both (86,87) of the opposing parts of the disks' surfaces related to the channel and confined between the opposing parts of the surfaces of the two adjacent vanes so that they are gradually sloping from the inlet of the channel towards its outlet.

In FIG. 9 the sweeping channel is slightly converging from its inlet towards its outlet. The convergence of the sweeping channel is provided by designing the boundaries confining the channel between them so that the axial width of the channel and the width between the opposing parts of the surfaces of the two adjacent vanes (89,90) confining the channel between them decrease gradually from the inlet of the channel towards its outlet, with the gradual decrease in the axial width of the channel provided by designing one (88) of the opposing parts of the disks' surfaces related to the channel and confined between the opposing parts of the surfaces of the two adjacent vanes so that it is gradually sloping from the inlet of the channel towards its outlet, and with the gradual decrease in the width between the opposing parts of the surfaces of the two adjacent vanes (89,90) provided by designing the vanes with suitable angles of inclination at their different parts, according to the desired angle of convergence of the channel.

In FIG. 10 the sweeping channel is slightly converging from its inlet towards its outlet. The convergence of the sweeping channel is provided by designing the boundaries confining the channel between them so that the axial width of the channel and the width between the opposing parts of the surfaces of the two adjacent vanes (93,94) confining the channel between them decrease gradually from the inlet of the channel towards its outlet, with the gradual decrease in the axial width of the channel provided by designing both (91,92) of the opposing parts of the disks' surfaces related to the channel and confined between the opposing parts of the surfaces of the two adjacent vanes (93,94) so that they are gradually sloping from the inlet of the channel towards its outlet, and with the gradual decrease in the width between the opposing parts of the surfaces of the two adjacent vanes provided by designing the vanes with suitable angles of inclination at their different parts, according to the desired angle of convergence of the channel.

In FIG. 11 the sweeping channel is slightly converging from its inlet towards its outlet. The convergence of the sweeping channel is provided by designing the boundaries confining the channel between them so that the width between the opposing parts of the surfaces of the two adjacent vanes (95,96) confining the channel between them decreases gradually from the inlet of the channel towards its outlet, with the gradual decrease in the width between the opposing parts of the surfaces of the two adjacent vanes (95,96) provided by designing the vanes with suitable angles of inclination at their different parts, according to the desired angle of convergence of the channel.

Certain modifications and improvements will occur to those skilled in the art upon a reading of the foregoing description. All modifications and improvements have been deleted herein for the sake of conciseness and readability but are properly within the scope of the following claims.

1. A rotary ram-out vacuum pump, used for decreasing the pressure of a gas within a container, said rotary ram-out vacuum pump comprising:
a stationary casing having at least one inlet passage communicating with said container, and at least one exit passage freely communicating with surrounding atmospheric air;
a drive shaft supported for rotation in a given direction inside the casing by an arrangement of bearings, and extending to a drive receiving end located outside the casing; and
a rotor assembly housed inside the casing and including a first disk secured for rotation with the drive shaft and lying in a first plane transverse to the rotational axis of the drive shaft; a second disk lying in a second plane transverse to the rotational axis of the drive shaft, with the inner surfaces of the two disks defining an annular space in-between; and a plurality of vanes arranged circumferentially within said annular space, each vane attached to both disks defining the annular space, each vane has a leading edge, a trailing edge, a concave surface and a convex surface, with the average angles of inclination of the successive portions of the vane with respect to a plane comprising the midpoint of the vane and perpendicular to a radial plane including the rotational axis of the rotor and the midpoint of the vane decreases preferably gradually from its leading edge towards its trailing edge, within a range from about +18 to about−18 degrees, the opposing parts of the surfaces of each two adjacent vanes along with the opposing parts of the two disks' surfaces confined between the opposing parts of the surfaces of each two adjacent vanes defining a sweeping channel between them, each sweeping channel has an inlet communicating with the vacuum pump's inlet passage and an outlet communicating with the vacuum pump's exit passage.

2. The rotary ram-out vacuum pump of claim 1, wherein the cross sectional area of the inlet of each of the said sweeping channels equals the cross sectional area of its outlet

3. The rotary ram-out vacuum pump of claim 1, wherein each of the said sweeping channels converges from its inlet towards its outlet

4. The rotary ram-out vacuum pump of claim 1, wherein the gas is rammed out of the said container, through said sweeping channels, in a relatively radially outward direction.

5. The rotary ram-out vacuum pump of claim 1, wherein the gas is rammed out of the said container, through said sweeping channels, in a relatively radially inward direction.

6. A rotary ram-out vacuum pump, used for decreasing the pressure of a gas in a space ahead of the vacuum pump, said rotary ram-out vacuum pump comprising:
a stationary casing having at least one inlet passage communicating with said space ahead of the vacuum pump, and at least one exit passage freely communicating with surrounding atmospheric air;
a drive shaft supported for rotation in a given direction inside the casing by an arrangement of bearings, and extending to a drive receiving end located outside the casing; and
a rotor assembly housed inside the casing and including a first disk secured for rotation with the drive shaft and lying in a first plane transverse to the rotational axis of the drive shaft; a second disk lying in a second plane transverse to the rotational axis of the drive shaft, with the inner surfaces of the two disks defining an annular space in-between; and a plurality of vanes arranged circumferentially within said annular space, each vane attached to both disks defining the annular space, each vane has a leading edge, a trailing edge, a concave surface and a convex surface, with the average angles of inclination of the successive portions of the vane with respect to a plane comprising the midpoint of the vane and perpendicular to a radial plane including the rotational axis of the rotor and the midpoint of the vane decreases preferably gradually from its leading edge towards its trailing edge, within a range from about +18 to about−18 degrees, the opposing parts of the surfaces of each two adjacent vanes along with the opposing parts of the two disks' surfaces confined between the opposing parts of the surfaces of each two adjacent vanes defining a sweeping channel between them, each sweeping channel has an inlet communicating with the vacuum pump's inlet passage and an outlet communicating with the vacuum pump's exit passage.

7. The rotary ram-out vacuum pump of claim 6, wherein the cross sectional area of the inlet of each of the said sweeping channels equals the cross sectional area of its outlet

8. The rotary ram-out vacuum pump of claim 6, wherein each of the said sweeping channels converges from its inlet towards its outlet

9. The rotary ram-out vacuum pump of claim 6, wherein the gas is rammed out of the said space ahead of the vacuum pump, through said sweeping channels, in a relatively radially outward direction.

10. The rotary ram-out vacuum pump of claim 6, wherein the gas is rammed out of the said space ahead of the vacuum pump, through said sweeping channels, in a relatively radially inward direction.
